(19) United States
(12) Patent Application Publication
(10) Pub. No.: US 2024/0079154 A1
(43) Pub. Date: Mar. 7, 2024

(54) CARBON NEGATIVE REACTORS

(71) Applicant: TAE TECHNOLOGIES, INC., Foothill Ranch, CA (US)

(72) Inventors: Ales Necas, Greensboro, NC (US); Toshiki Tajima, Foothill Ranch, CA (US)

(21) Appl. No.: 18/239,835

(22) Filed: Aug. 30, 2023

Related U.S. Application Data
(63) Continuation of application No. PCT/US2022/018241, filed on Mar. 1, 2022.
(60) Provisional application No. 62/154,964, filed on Apr. 30, 2015.

(51) Int. Cl. G21C 15/12; G21C 15/26

(52) U.S. Cl. CPC G21C 15/12; G21C 15/26

(57) ABSTRACT

First-wall systems and methods for FRC based aneutronic fusion reactors or photon reactors, and fission or transmutation molten salt reactors that facilitate the management and handling of all aspects of energies, fluxes and particles.

### CROSS-REFERENCE TO RELATED APPLICATIONS

The subject application is a continuation of International Patent Application No. PCT/US22/18241, filed Mar. 1, 2022, which claims priority to U.S. Provisional Patent Application No. 63/154,964, filed on Mar. 1, 2021, both of which are incorporated by reference herein in their entireties for all purposes.

### FIELD

The subject matter described herein relates generally to the utilization of carbon nanomaterials (CNM)) in nuclear fusion and fission reactors and, specifically, not by way of limitation, to the application of CNM in reactor walls.

### BACKGROUND

Energy producing reactors such as fusion reactors [Ref 1], fission reactors [Ref. 2], and transmutators [Ref. 3] need to have a series of walls to confine the high energy and radiation producing central chamber(s). These walls, in part, can act as a cooling system of the reactor. Traditionally, walls are cooled through pipes with coolant circulated by a pumping system. This pumping system extracts heat and transports it outside of the central region. When the pumping system malfunctions (e.g., due to the lack of electricity), heat removal stalls. Accordingly, what is needed is an improved wall design to remove heat without the need of an external power source.

### SUMMARY

The example embodiments provided herein are generally directed to first and subsequent wall systems and methods for fusion and fission reactors that facilitate the management and handling of all aspects of energies, fluxes and particles. The example embodiments provided herein are also generally directed to the utilization of a system of pipes, including nanotubes, graphene and other nanometric carbon structures (collectively referred to as carbon nanomaterials (CNM)) and to the utilization of CNM for fusion and fission reactors, and, more particularly, without by way of limitation, to the utilization of CNM in the walls of such reactors where chemical, photoelectrochemical, or photocatalysis conversion of CO2 renders the reactors carbon negative or enables other photoelectrochemical reactions such as, e.g., water splitting. Other example embodiments described herein relate to the utilization of the fission and fusion generated heat within the reactors to drive chemical reactions such as, e.g., Sabatier reactions or Haber processes. This carbon negative energy conversion from heat and photon energy into chemical energy may be considered as an additional cooling mechanism within the wall of reactors similar to a mechanism found in trees. Such mechanism is referred to hereinafter as the “artificial tree”.

In field-reversed configuration (FRC) based aneutronic fusion reactors or photon reactors, the wall system is multi-layered and multi-functional with each layer performing a specific role. The first wall embodiments for the photon reactor are preferably referred to as a “soft-wall” configuration as opposed to a “hard-wall” configuration. In example embodiments, the “soft-wall” configuration includes a low-Z material with a thin, large surface-to-volume ratio wall that includes a variety of bio-inspired and nano-inspired features to handle energy and particle flux.

In example embodiments, the wall materials are tensile-strong but bendable and flexible, replaceable and self-healing, and possess high heat and electrical conductivity.

In example embodiments, the soft first wall is transparent to high-energy photons but is designed to either absorb or reflect low energy photons. Reflected photons reenter and heat the FRC plasma.

In example embodiments, the first soft-wall is composed of carbon nanotubes (CNT), diamond or graphene and other carbon allotropes.

In example embodiments, a thin cloth (or weaved clothes) of diamond, diamond-based compounds, or carbon-nanotube (CNT) fabric form a first wall, which, in a fusion reactor, separates the interior vacuum and from the outside, or, in a transmutator, separates two or more chambers that contain liquid nuclear materials. Such thin cloth (or wall) may be supported with struts positioned around the cloth at predetermined intervals. The struts, which may be made up again with diamond, materials similar to diamond, or low-Z metals, provide mechanically needed strength. Such a first wall made of carbon should be sturdier than its metallic version both physically and chemically under the conditions of fusion first walls.

In example embodiments, the walls of fusion devices are formed via chemical vapor deposition (CVD).

In example embodiments, the walls of fusion devices are formed via 3D printing.

In example embodiments, the carbon-based wall of the fusion device is doped with nitrogen or some other dopant to suppress an electrical breakdown near the surface by strongly affecting secondary electron emission rate from the diamond surface.

In example embodiments, the carbon-based walls are replaceable while the fusion device and the transmutator are operating. The network of carbon fabric that are attached to the system of struts may be moved like a mechanism such as, e.g., a conveyer-belt, so that the old parts of the fabric may be replaced easily by the new specimens of similar materials and wall elements.

In example embodiments, operation and control of the carbon-based walls are facilitated through artificial neural network control systems and methods.

In example embodiments, the diamond based walls are interrogated and diagnosed in-situ and online with Raman spectroscopy. While operating, fusion devices emit large fluxes of neutrons (D-T fusion) or X-rays (p-B¹¹ fusion) as well as fluxes of plasma and accompanying heat flux of several 10s MW/m². In the case of a transmutator, the wall is in contact with high temperature (600 degC) molten salt (LiF—BeF) where fission products and minor actinides are dissolved, and is subject to high flux of neutrons. Thus, it is inevitable the diamond based wall will sustain damage over long periods of operation. The damage will be in the form of DPA in the case of neutrons, corrosion in the case molten salts, and creeping in the case of fission products (Tellurium e.g.).

In example embodiments, the cooling of the fusion reactor walls is facilitated by passing a coolant in pipes embedded within the wall. In other example embodiments, coolant is pumped through CNTs within the wall due to capillary action within the CNTs providing part (or most of) of the necessary pumping force. In the case of loss of power to the pumps, the CNT capillary action can still function thus providing a passive safety mechanism referred to herein as an “artificial tree”. The CNT tubular (capillary) structure also provides superior surface to volume ratio so that the heat exchange rate is huge acting as a superior cooling system. Further, we note that CNT has the benzene electronic structure (the collective quantum mechanical special electron chemical bond that has extremely large electronic and heat transport in the plane of the benzene bond plane, while the covalent bonds perpendicular to the benzene plane makes CNT plane is robust and insulating).

In example embodiments, photons absorbed in the CNTs are utilized for the photoelectrochemical or photocatalyst reactions. A certain part of the photon spectrum is used to facilitate photoelectrochemical, or the photocatalysis reactions, such as, e.g., artificial photosynthesis, water splitting, carbon dioxide to carbon monoxide conversion and the like.

In example embodiments, the infrared part of the photon spectrum is used for heating coolant such as water, molten salt etc. Heated coolant is transported to a chemical factory to drive energy intensive chemical reactions such as Haber processes to generate ammonium, and Sabatier reactions to consume carbon dioxide to produce methane and the like.

In further example embodiments, energy extraction and cooling of fission reactors, including but not limited to the thermal neutron reactors or fast reactors, is facilitated by passing a CNT based cooling component through the core of the reactor with a coolant pumped through the CNTs of the cooling component. Coolant flow through the CNTs is facilitated by capillary action thus enabling the cooling system to operate without pump in a passive safety mode.

In further example embodiments, extracted heat from the fission reactor core is used in a chemical factory to drive energy intensive chemical reactions such as Haber processes to generate ammonium, Sabatier reactions to consume carbon dioxide to produce methane, and the like.

Advantages of the example embodiments of diamond and carbon based allotropes for the use as a first wall for fusion device and for the transmutator include:
a. Low-Z;
b. Can be grown to various thickness; for polycrystalline diamond thickness does not have physical restriction, just technical and practical.
c. Different grades of diamond can be fabricated: single-crystal, polycrystalline (microcrystalline, nanocrystalline, ultrananocrystalline). Doped/undoped. The choice of using the particular grade is strongly determined by the application.
d. Polycrystalline diamond can be grown to area up to several hundreds of mm in diameter. Nanodiamond can be grown on substrates as large as several meters. For single crystal diamond large area is a problem.
e. Corrosion resistance with molten salts, fission products or minor actinides;
f. Adequate strength at elevated temperatures;
g. Low dielectric loss (tangent delta). This could be relevant if application involves scattered microwaves, which can be introduced in a fusion device for plasma heating.
h. Low activation;
i. Very low tritium retention;
j. Fatigue resistance;
k. Maintains good ductility after irradiation;
l. Helium creep resistance;
m. CVD diamond material can be engineered to the application. Many types of diamond and diamond-like materials are not exotic and available “off the shelf”.
n. Mechanically strength and hardiness among the strongest to the covalent tetrahedral bonds;
o. It has low neutron damage or DPA (displacement per atom) [Ref. 16];
p. Very high thermal conductivity (khi_diamond˜5*khi_Cu) and;
q. Very low electrical conductivity or potentially an insulator with a high resistance to electric breakdown. Diamond breakdown electric field ˜10 MeV/cm˜0.3 eV/atomic distance of 3 Angstrom.
r. Doped to limit electrical conductivity in 2 dimensions, and;
s. Boron doped electrically conducting layer may be inside the diamond and is not just limited to the surface.

Other systems, methods, features and advantages of the example embodiments will be or will become apparent to one with skill in the art upon examination of the following figures and detailed description.

### BRIEF DESCRIPTION OF FIGURES

The details of the example embodiments, including structure and operation, may be gleaned in part by study of the accompanying figures, in which like reference numerals refer to like parts. The components in the figures are not necessarily to scale, emphasis instead being placed upon illustrating the principles of the disclosure. Moreover, all illustrations are intended to convey concepts, where relative sizes, shapes and other detailed attributes may be illustrated schematically rather than literally or precisely.

FIG. 1 illustrates a perspective view of the main components of a beam driven FRC plasma fusion reactor.

FIG. 2A illustrates the steady state location of the plasma, the various channels for particle fluxes, walls location and coolant direction. In this representation vacuum wall is also the plasma facing wall.

FIG. 2B illustrates a partial cross-sectional view of the fission reactor wall of the reactor in FIG. 2A. In this representation vacuum wall is also the plasma facing wall.

FIG. 2C illustrates a cooling system within the reactor wall in accordance with some embodiments of the present disclosure.

FIG. 2D illustrates a carbon nanotube (CNT) bundle.

FIG. 2E illustrates single walled, double-walled or multi-walled CNTs.

FIGS. 2F and 2G are photographs illustrating CNT cloth.

FIG. 2H illustrates a partial cross-sectional view of the fission reactor wall of the reactor in FIG. 2A with strut supports.

FIGS. 2J and 2K illustrate a partial cross sectional view of the CNT cloth replacement system.

FIG. 3 illustrates the steady state location of the plasma, the various channels for particle fluxes, walls location and coolant direction. In this representation the vacuum wall is placed at the interface with air.

FIGS. 4 and 5 illustrate schematic diagrams of the fission or transmutation molten salt reactors having a wall and systems for cooling and chemical processing in accordance with some embodiments of the present disclosure.

### DETAILED DESCRIPTION

Each of the additional features and teachings disclosed below can be utilized separately or in conjunction with other features and teachings to provide first wall systems and methods for FRC based aneutronic fusion reactors or photon reactors. Representative examples of the embodiments described herein, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the disclosure. Therefore, combinations of features and steps disclosed in the following detail description may not be necessary to practice the disclosure in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

The example embodiments provided herein are generally directed to first and subsequent wall systems and methods for fusion and fission reactors that facilitate the management and handling of all aspects of energies, fluxes and particles. The example embodiments provided herein are also generally directed to the utilization of a system of pipes, including nanotubes, graphene and other nanometric carbon structures (collectively referred to as carbon nanomaterials (CNM)) and to the utilization of CNM for fusion and fission reactors, and, more particularly, without by way of limitation, to the utilization of CNM in the walls of such reactors where chemical, photoelectrochemical, or photocatalysis conversion of CO₂ renders the reactors carbon negative or enables other photoelectrochemical reactions such as, e.g., water splitting. Other example embodiments described herein relate to the utilization of the fission and fusion generated heat within the reactors to drive chemical reactions such as, e.g., Sabatier reactions or Haber processes. This carbon negative energy conversion from heat and photon energy into chemical energy may be considered as an additional cooling mechanism within the wall of reactors similar to a mechanism found in trees. Such mechanism is referred to hereinafter as the “artificial tree”.

With the additional cooling mechanism or artificial tree cooling system, two main functions come into play. The first is a carbon negative chemical process that converts heat energy (or photon energy) in the pipes or pipe surfaces into chemical potential energy by producing CO₂ into some chemical product. This carbon negative fixation process not only removes CO₂, but also removes heat (or photon) energy adding to the overall cooling. In part of the wall, nanometric wall materials comprising nanotubes can be used such that the capillary force within the nanotubes can act as a coolant moving mechanism. The second main function is the vaporization process that acts as part of the coolant pumping system reducing the external pumping power needed to operate the cooling system.

FRC based aneutronic fusion machines, which would utilize pB11 plasma or the like, is considered a photon reactor rather than a conventional neutron reactor based on DT fusion, e.g., tokamak. Photon reactors experience high fluxes of photons from high energy gamma rays and X-rays and low energy infrared (IR) rays, charged particles in the form of electrons, protons, alpha particles, boron, and neutrals in the form of hydrogen and helium. A low flux of neutrons is also present. With such reactors, it is imperative to construct walls that facilitate safe handling and management of heat and particle fluxes.

The first wall of the fusion reactor needs to be thin and made up of low-Z materials to enable the passage of most of the high fluxes of photons and charged particles, and provides significant heat management and deposition, as well as handle a low flux of neutrons, which lead to volumetric heating and activation. Challenges associated with charged particle bombardment include, among others, blistering, embrittling and sputtering. Low energy photons may be absorbed on the first wall and can be cooled by a coolant and have their energy converted. Meanwhile, secondary walls and tanks of fusion and/or fission reactors, and molten salt transmutators, handle and absorb all other radiations, including neutrons. In addition, a circuit of additional pipes can be incorporated in the walls creating the artificial tree cooling mechanism. Liquid within the additional pipes can act to convert the heat from these walls and tanks via heat induced or low energy photon induced chemical energy conversion.

Mid-range energy photons are used directly to drive photoelectrochemical or photocatalyst reactions.

Low energy photons are used as a source of volumetric heating to drive energy-intensive chemical reactions.

The generated photons can be utilized for various processes including but not limited to thermochemical, electrochemical reduction, or artificial photosynthesis.

In a fission reactor, including but not limited to the thermal neutron reactors or fast reactors, heat extraction is accomplished either by a pipe inside the core carrying a coolant or alternatively pump the liquid core into a heat exchanger.

Extracted heat is repurposed to drive energy intensive chemical reactions such as thermochemical or electrochemical reactions.

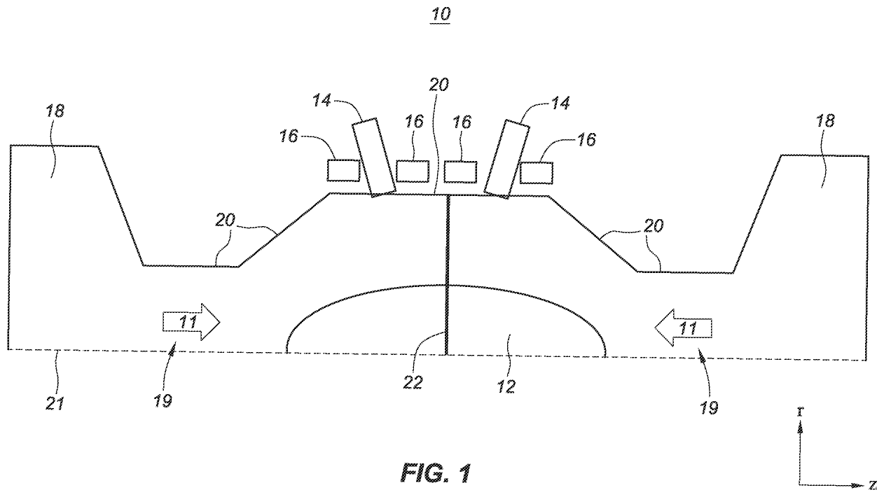

Turning to the figures, a beam-driven FRC based fusion machine 10 having an FRC plasma 12 is shown in FIG. 1. The fusion machine 10 and FRC plasma 12 exhibit left-right symmetry around an axis 22 called the midplane, and up-down symmetry about a longitudinal axis 21. In example embodiments, a proton plasma 11 is formed in each of first and second formation sections 19 and translated at super-thermal velocities toward the mid-plane of the fusion machine 10 and merged to form the single final FRC plasma 12. Negative ion based neutral beams 14, such as, e.g., proton and boron, provide fueling, current drive, and stabilization of the FRC plasma 12. Further plasma stabilization and confinement is provided by a plurality of magnets 16 and wall 20 of the machine 10.

Charged particles generated in the FRC plasma 12 flow primarily along a z-direction and are collected in first and second divertors 18. Photons in the form of bremsstrahlung X-rays and infrared synchrotron radiation tend to be emitted from the FRC plasma 12 in all directions impacting the wall 20 of the machine 10. The wall 20 is the vacuum vessel wall and may be 1 m thick. A high level of vacuum (10-6 torr) is needed to prevent breakdown of the FRC plasma 12.

The wall 20 is configured to provide safe handling of heat and electromagnetic energy as well as facilitate the management of various ionizing radiation.

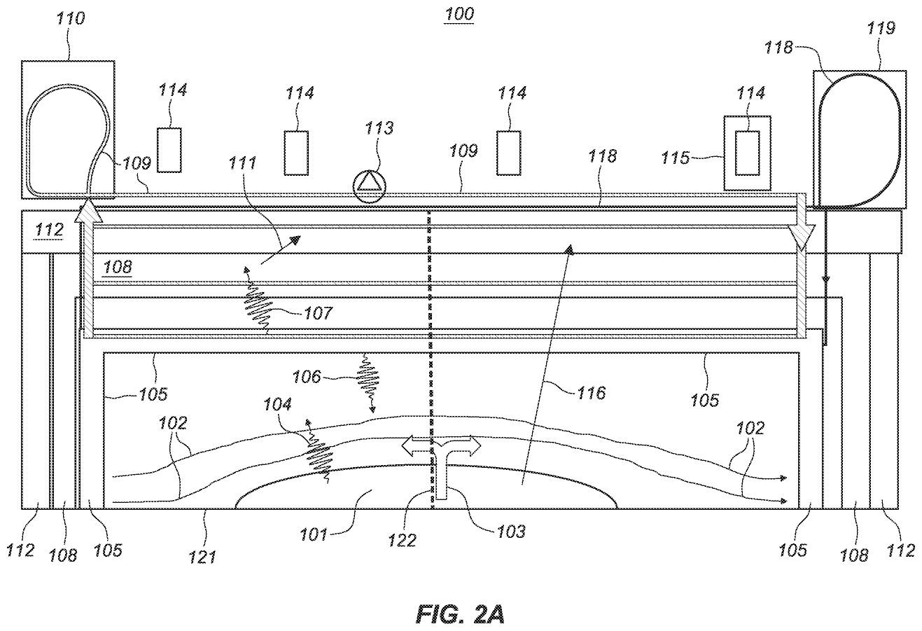

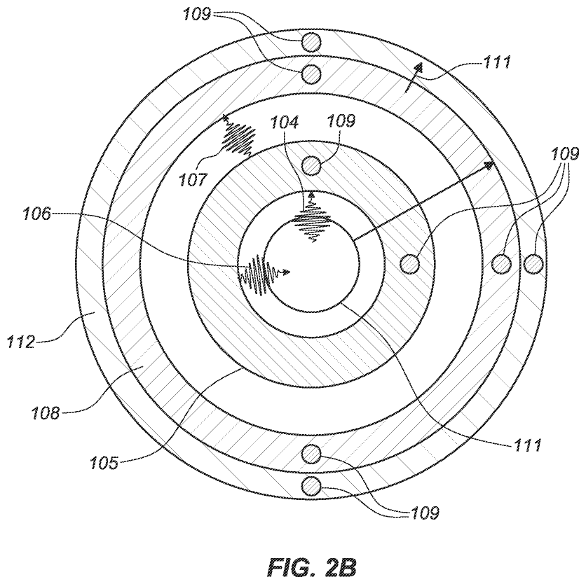

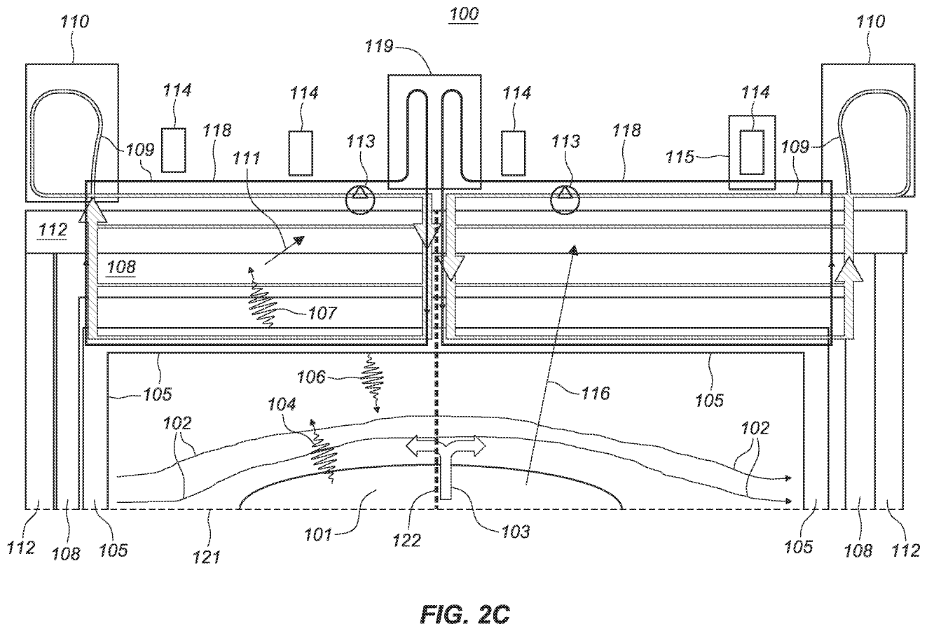

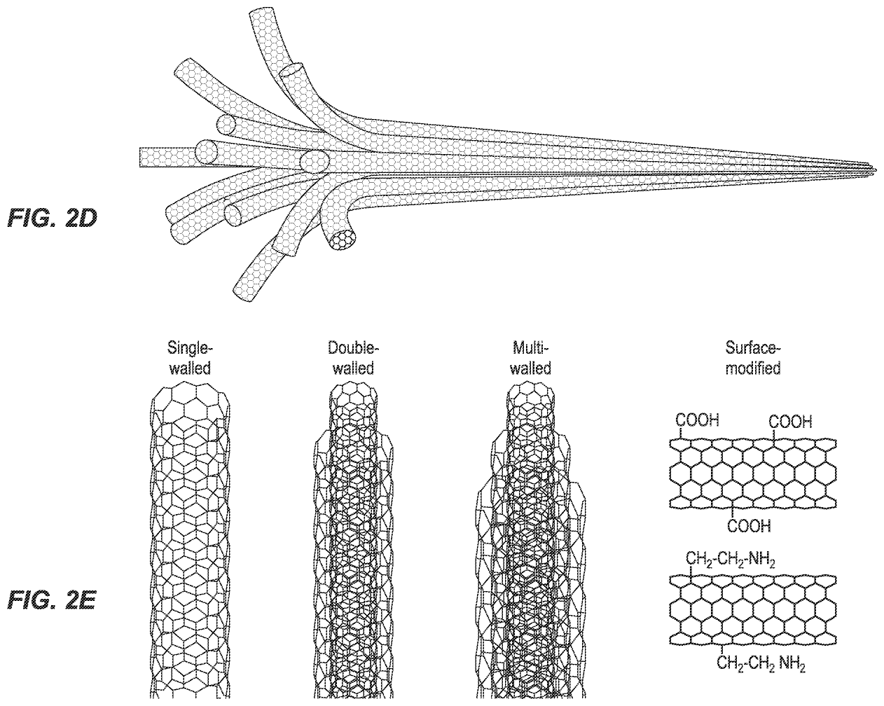

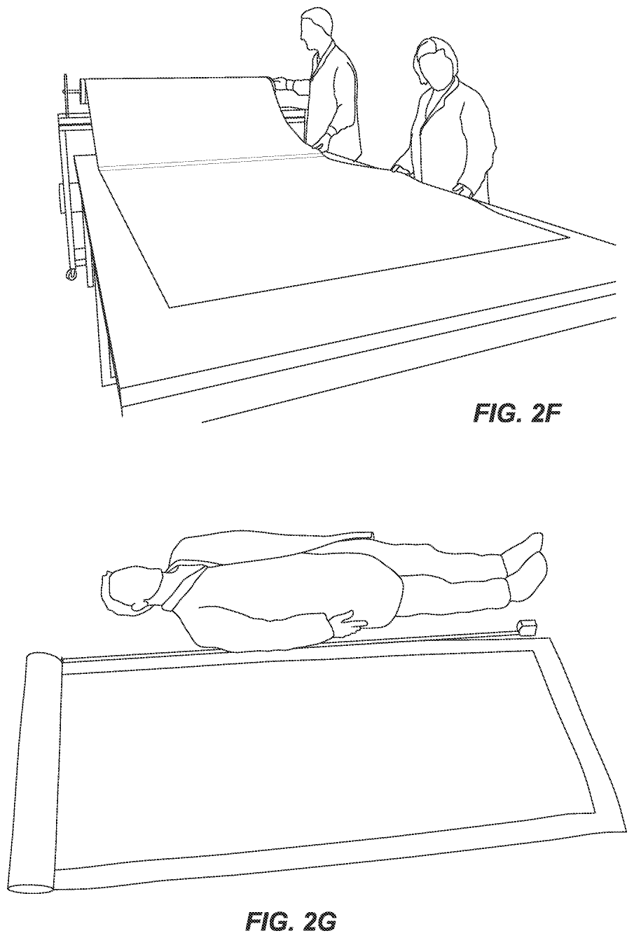

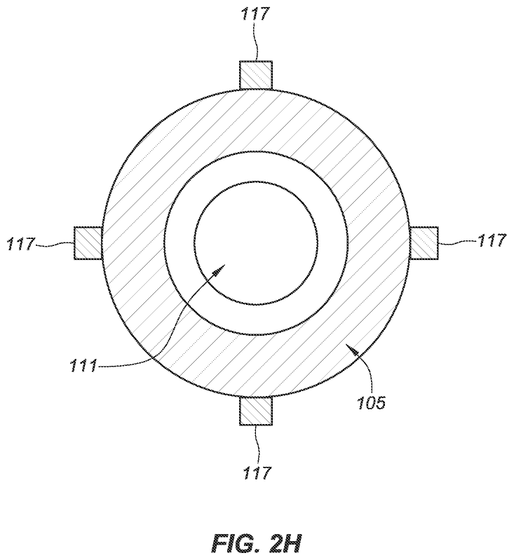

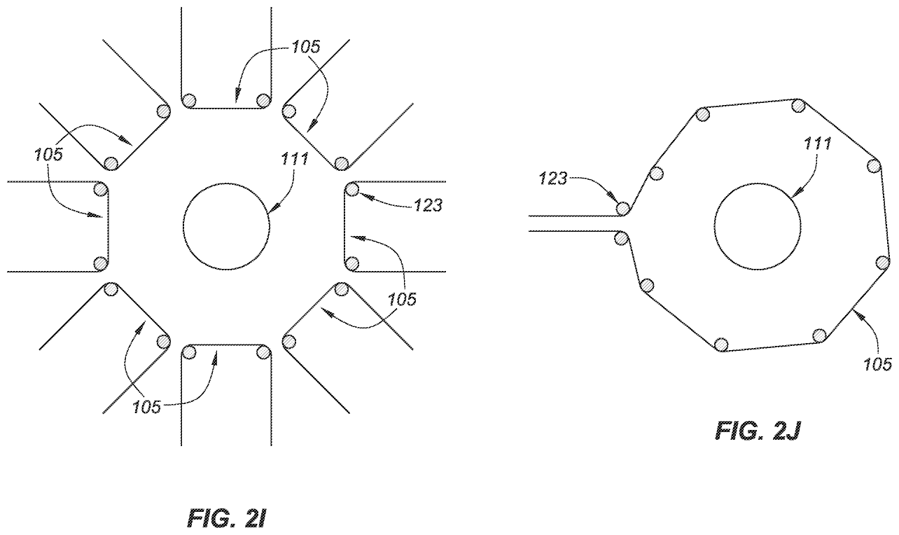

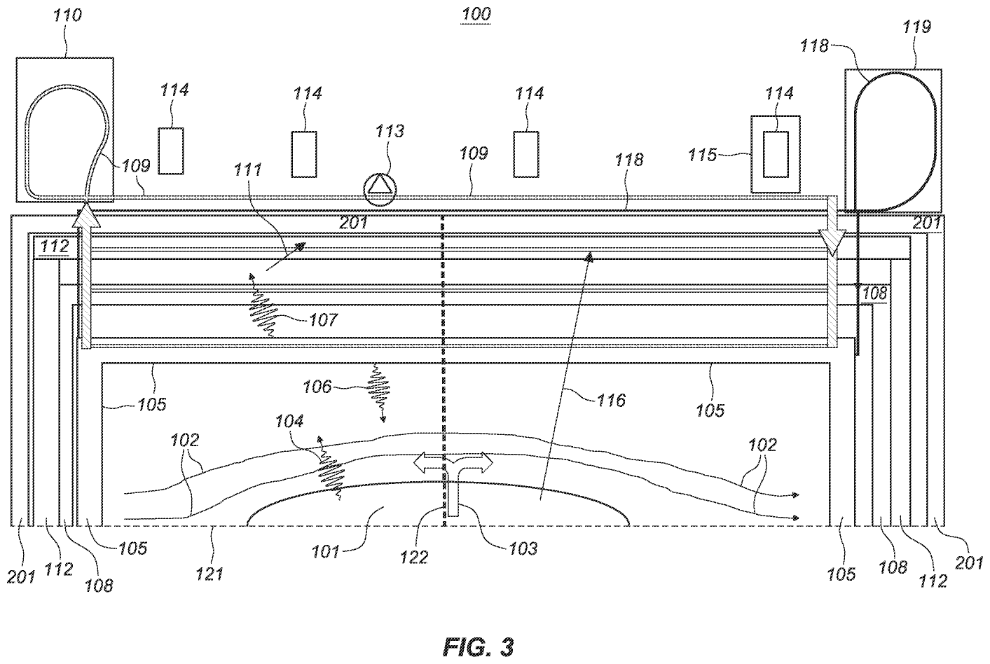

Turning to FIGS. 2A and 2B, partial views of a fusion reactor 100 with the FRC plasma 101 immersed within a magnetic field structure 102 is shown.

The FRC plasma 101 is composed of ions such as, e.g., proton and boron ions, with electrons maintaining the plasma quasi-neutral. The fusion of proton-boron ions generates alpha particles which are then exhausted along the magnetic field lines 102. Portions of the proton-boron plasma 101 which do not fuse, i.e., non-fused plasma 103, are transported out radially and then exhausted axially along the magnetic field lines 102. All charged particles exhausted are directed along the field lines 102 into the divertors 18 shown in FIG. 1.

Photons 104 are emitted isotropically from the plasma 101 toward the first wall 105. The photons are generated by three distinct mechanisms: (1) Bremsstrahlung, (2) Synchrotron or magneto-bremsstrahlung, and (3) nuclear reactions. The photon energy spectrum spans from the infrared range to x-rays and gamma rays. The photons do not interact with the electromagnetic field and travel in straight lines.

The first wall 105 is configured to reflect, absorb and transmit photons 104 depending on their energy, to be transparent to neutrons 116, and to be either absorbing, reflecting or transparent to charged particles depending on their energy. Low energy photons are absorbed, mid-range energy photons (e.g., ultraviolet) are partially absorbed and partially reflected, and X and gamma rays are transmitted.

Reflected mid-range energy photons 106 from the first wall 105 are reabsorbed by the FRC plasma 101 and heat the FRC plasma.

Low energy photons absorbed in the first wall 105 are converted into heat. A pipe 109 delivers coolant through the wall 105 to divert the heat to a heat exchanger 110 to turn into usable electricity or to drive energy intensive thermochemical reactions, e.g., Haber processes or Sabatier reactions to convert CO₂.

The coolant carrying pipe 109 is a CNT bundle as shown in FIGS. 2D and 2E. The CNT can be single walled, double-walled or multi-walled construct.

The first wall 105 is made from CNT cloth [Ref. 4] as shown in FIGS. 2F and 2G [Ref 5]. Several layers of CNT cloth can be woven together.

CNTs in the first wall 105 can have a thermal conductivity as large as 3500 W/(m*K) (compared with 300 W/(m*K) for copper) to enable the transport of a heat load away from the wall.

Heat management in the first wall 105 is accomplished in three ways: (1) Coolant in the pipe 109. (2) Large thermal conductivity of the CNT cloth. (3) Coolant delivered by a pipe 118 and driven through CNT cloth of the first wall 105 by capillary action and evaporation, which is referred to herein as the artificial tree.

The coolant in the pipe 109 can be water infused with nanoparticles dispersed to form a nanofluid to improve heat transport. The nanoparticles can be alumina, silica or CNT to increase the heat transfer capabilities.

The artificial tree cooling pipe 118, like the cooling pipe 109 extending through the first wall 105, is composed of a CNT bundle shown in FIGS. 2D and 2E, and is connected and delivers a coolant to the CNT cloth of the first wall 105. The coolant can include, but is not limited to, water or CO₂. The CO₂ coolant can be broken down by artificial photosynthesis into either carbon monoxide or hydrocarbons (e.g. methane). This process is a part of the bio-inspired first wall.

The extracted heat or converted CO₂ by-products from the first wall 105 are delivered to a heat or gas exchanger 119.

Utilizing CNT bio-inspired capillary action and evaporation in the pipe 109 allows coolant flow in a manner that eliminates or reduces the need for pumps. To improve coolant flow, pump 113 is coupled to the pipe 109 and used to pump coolant through the pipe 109.

A CNT can be ˜1-100 nm in diameter and span the length of the fusion machine 100. CNTs are grown using the chemical vapor deposition process. CNTs can be processed into a CNT yarn [Ref 6], [Ref. 7] which in turn can be woven into a CNT cloth or fabric [Ref 4].

CNT defects can be directly healed by laser [Ref. 8] or vacuum arc annealing [Ref. 9]. Defective CNTs are also known to self-heal [Ref. 10].

The transmitted high energy photons 107 are absorbed by a high-Z material in a second wall 108. Photon absorption in a material scales with Z4, where Z is the number of electrons or protons. Materials for the second wall 108 include, but are not limited to, lead or polymer-matrix metal composites. Absorbed high energy photons are converted into heat that is removed by a coolant moving in the pipe 109 passing through the second wall 108.

A low flux of neutrons is generated via two processes: (1) In the plasma 101 in a secondary reaction generating neutrons 116; (2) By photonuclear process in the second wall 108 generating photo-neutrons 111. Neutrons interact weakly with matter and the first wall 105 is transparent to them. Furthermore, the high-Z composition of second wall 108 will render the second wall transparent to neutrons. Thus, a third wall 112 is provided to handle all aspects of neutron moderation and capture.

The third wall 112 is composed of low to moderate Z material that moderates and absorbs neutrons. An example material for the third wall 112 is a boron carbide.

In other example embodiments, the third wall 112 is a water tank with boric acid dissolved to aid neutron absorption and moderation. Other potential materials include, but are not limited to, Mg(BH4)2 or TiH2.

In addition to heating, absorbed mid-range energy photons 104 are utilized to drive photoelectrochemical and photocatalytic (artificial photosynthesis) reactions in the wall 105. Target reactions include, but are not limited to, splitting water into oxygen and hydrogen, reduction of carbon dioxide into carbon monoxide or other hydrocarbons.

Charged particles are exhausted along the magnetic field lines 102 in FIG. 2A to a divertor 18 shown in FIG. 1. The machine 100 in FIG. 2A is designed to extract usable energy from charged particles via a systems of electromagnetic converters (not shown), thus any charged particles impacting walls are low energy.

CNTs have no structural damage when irradiated by electrons with energy below 100 keV [Ref. 11].

CNT tensile strength has been shown to increase when irradiated with protons [Ref 12]. Another study has shown that CNTs are very tolerant to proton irradiation [Ref. 13].

CNTs possess the highest surface to volume ratio with a 1350 m2/g theoretical surface area estimated [Ref 14] (6 g of CNT have a surface area of a football field). Thus any neutral gas (including low energy alpha or helium) impinging at the CNT based first wall will have a very high likelihood of adsorbing onto the surface. Standard glow or arc discharge will release the adsorbed gases during a maintenance process in which vacuum pumps are removed from the machine.

In the embodiment shown in FIG. 2A, the nano-carbon based first wall 105 is also the vacuum wall and maintains vacuum inside the reactor core where the FRC plasma 101 is located.

A plurality of magnets 114 maintains a background magnetic field to confine the plasma. A shield 115 protects the cryostat and the superconducting magnets 114 from any stray radiation.

The magnet shielding 115 is designed from Mg(BH4)2 or TiH2.

In an alternative example embodiment, the wall 105 is partially or fully covered with photovoltaic cells to convert photons to electricity directly.

In a case of unused electricity, e.g., during low consumption, electricity can be diverted to initiate CO₂ conversion including but not limited to electrochemical reduction of carbon dioxide.

In order to convert CO₂, CO₂ must first be collected. CO₂ can be trapped by a process as described in [Ref 15]. CO₂ can be collected inside buildings but also in places of high average wind such as, e.g., mountain passes and other places that favor wind turbines.

An alternative example embodiment of the cooling system is illustrated in FIG. 2C. The cooling system is a split system where coolant is delivered at the midplane 122 for all the walls using pipe 109 and the first wall using pipe 118 respectively. The pipe 118 will add to the transport of the CO₂ coolant to convert in the first wall 105.

Referring to FIG. 2B, a cross-sectional view of the fusion reactor 100 in FIG. 2A along the midplane 122 is shown. The fusion reactor 100 includes a first wall 105 facing a plasma 111 along with second and third walls 108 and 112. A plurality of cooling pipes 109 is shown in an example configuration.

Turning to FIG. 2H, the plasma facing first wall 105 of FIG. 2A is depicted. As noted above, a CNT cloth of the first wall 105 possesses high tensile strength but is bendable. In some example embodiments, struts 117 are used for support the CNT cloth of the first wall 105 to prevent the first wall 105 from collapsing. Such a system of supports and struts provides an exoskeleton-like structure similar to the tent poles of a tent.

The first wall 105 can also be configured to be replaceable. The CNT cloth of the first wall 105 can be supported by rollers as illustrated in FIG. 2F. FIGS. 2J and 2K illustrate examples of a system of rollers 123 supporting the CNT cloth forming the first wall 105. CNT cloth is fed along the indicated arrows to become the plasma facing first wall 105. Once the wall 105 suffers damage, the CNT cloth can be rolled out and fresh portion of CNT cloth can be rolled in to become the plasma facing first wall 105. Additionally, instead of rollers 123, stationary support structures with very low friction can be used to support the CNT cloth.

CNT cloth is either discarded or the CNT cloth can be healed as described above in [Ref 4], [Ref. 5] and [Ref. 6].

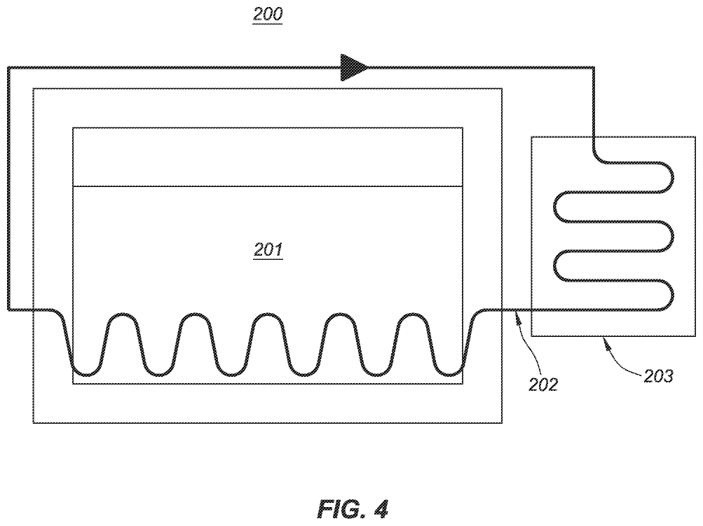

Referring to FIG. 3, an alternative example embodiment is shown to include a vacuum wall 201 encompassing first, second and third walls 105, 108 and 112.

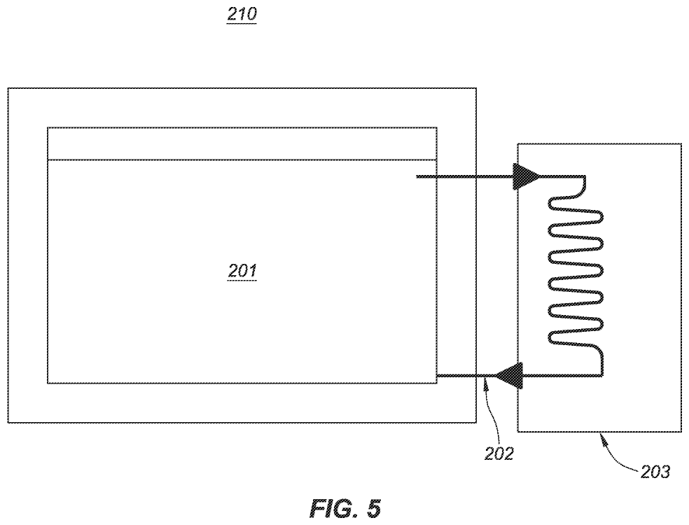

Referring to FIGS. 4 and 5, example embodiments of a fission or transmutation molten salt reactors (MSR) 200 are shown. The MSR 200 operates whereas fuel (uranium, plutonium, and other actinides) forms the core, 201, of the MSR 200. Cooling is critical for a MSR with most of the heat stored in a liquid core, 201. A small amount escapes the system in the form of neutrons and gamma radiation.

To remove heat from the core 201 of fission or transmutation MSR 200, a bundle of CNTs, 202, transport a coolant through the core, 201. The coolant is moved through the CNTs by the combination of three processes with each process capable working individually: (1) a pump, (2) by the capillary action, (3) by evaporation. The last 2 processes, referred to as an artificial tree, are inspired by the capillary system of a tree.

The capillary action is due to the forces of adhesion, cohesion and surface tension, whereas the evaporation is driven by the osmotic pressure differential.

CNT bundle, 202, transports the heating coolant into the heat exchanger, 203, to deposit the heat. This heat energy can be used to drive energy intensity thermochemical reactions such as Sabatier reaction or Haber process.

In an alternative example embodiment MSR 210, the hot liquid, 201, is transported through the CNT bundle, 202, into the heat exchanger, 203, without the use of additional coolant. The heat exchanger serves to absorb heat energy and drive energy intensity reactions such as Sabatier reaction or Haber process.

As previously mentioned for the fusion reactor, any unused electricity generated by the fission reactor maybe used for to drive electrochemical processes including but not limited to electrochemical reduction of carbon dioxide to carbon monoxide.

### REFERENCES

[1] M. W. Binderbauer et al., A high performance field-reversed configuration, Phys. Plasmas, 22, (2015).
[2] P. N. Haubenreich and J. R. Engel, Experience with the Molten-Salt Reactor Experiment, Nucl. Appl. Technol., 8, 118, (1970).
[3] T. Tajima, A. Necas, G. Mourou, S. Gales, and M. Leroy, Spent Nuclear Fuel Incineration by Fusion-driven Liquid Transmutator Operated Realtime by Laser, Fusion Sci. Technol., in print, (2021).
[4] X. Luo et al., Multifunctional fabrics of carbon nanotube fibers, J. Mater. Chem. A, 7, 8790, (2019).
[5] Miralon® Sheet and Tape. [Online]. Available: https://www.miralon.com/sheet/tape. [Accessed: 28 Feb. 2021].
[6] T. J. Mun et al., Wearable energy generating and storing textile based on carbon nanotube yarns, Adv. Funct. Mater., 30, 2000411, (2020).
[7] X.-H. Zhong et al., Continuous multilayered carbon nanotube yarns, Adv. Mater., 22, 692, (2010).
[8] H. H. Van, K. Badura, R. Liang, O. Okoli, and M. Zhang, Laser-induced graphitic healing of carbon nanotubes aligned in a sheet, J. Laser Appl., 29, 22010, (2017).
[9] J. T. H. Tsai, J. Li, and A. Tseng, Defect healing of carbon nanotubes by rapid vacuum arc annealing, MRS Online Proc. Libr., 1057, 1, (2007).
[10] C. L. Zhang and H.-S. Shen, Self-healing in defective carbon nanotubes: a molecular dynamics study, J. Phys. Condens. Matter, 19, 386212, (2007).
[11] L. I. Bin, F. Yi, K. Ding, Q. Gang, X. Zhang, and Y. Liu, Effect of electron beam irradiation on multi-walled carbon nanotubes, Trans. Nonferrous Met. Soc. China, 24, 764, (2014).
[12] J. G. Gigax, P. D. Bradford, and L. Shao, Ion beam modification of carbon nanotube yarn in air and vacuum, Materials (Basel), 10, 860, (2017).
[13] W. K. Hong, C. Lee, D. Nepal, K. E. Geckeler, K. Shin, and T. Lee, Radiation hardness of the electrical properties of carbon nanotube network field effect transistors under high-energy proton irradiation, Nanotechnology, 17, 5675, (2006).
[14] A. Peigney, C. Laurent, E. Flahaut, R. R. Bacsa, and A. Rousset, Specific surface area of carbon nanotubes and bundles of carbon nanotubes, Carbon N. Y., 39, 507, (2001).
[15] S. Fujikawa, R. Selyanchyn, and T. Kunitake, A new strategy for membrane-based direct air capture, Polym. J., 1, (2020).
[16] M. Angelone, M. Pillon, A. Balducci, et al., “Radiation hardness of a polycrystalline chemical-vapor-deposited diamond detector irradiated with 14 MeV neutrons,” Review of Scientific Instruments 77, 023505 (2006).

All features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. Express recitation of every possible combination and substitution is overly burdensome, especially given that the permissibility of each and every such combination and substitution will be readily recognized by those of ordinary skill in the art upon reading this description.

In many instances entities are described herein as being coupled to other entities. It should be understood that the terms “coupled” and “connected” or any of their forms are used interchangeably herein and, in both cases, are generic to the direct coupling of two entities without any non-negligible e.g., parasitic intervening entities and the indirect coupling of two entities with one or more non-negligible intervening entities. Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

1. A cooling system of a reactor, the cooling system comprising:
a first wall comprising a low-Z material configured to absorb low energy photons;
a second wall comprising a high-Z material; and
a carbon nanotube (CNT) based network extending through the first wall.

2. The cooling system of claim 1, further comprising a plurality of pipes extending through the first and second walls.

3. The cooling system of claim 2, wherein the CNT based network comprising a plurality of CNT bundles forming one or more of the plurality of pipes.

4. The cooling system of claim 1, wherein the CNT based network forming the first wall, wherein the cooling system is configured to drive coolant through each CNT via capillary action.

5. The cooling system of claim 4, wherein the CNT based network including one or more CNT bundles forming a plurality of pipes extending through the first wall.

6. The cooling system of claim 1, wherein the first wall forms a vacuum wall of the reactor.

7. The cooling system of claim 1, wherein the reactor includes a vacuum wall disposed beyond the first and second walls.

8. The cooling system of claim 1, further comprising a third wall configured to absorb neutrons.

9. The cooling system of claim 8, wherein the third wall comprises boron carbide.

10. The cooling system of claim 8, wherein the third wall comprises a tank having a liquid configured to absorb neutron.

11. The cooling system of claim 1, wherein the first wall is configured to partially absorb and reflect mid-range energy photons.

12. The cooling system of claim 1, further comprising a heat exchanger configured to extract heat from the CNT based network that is routed therethrough.

13. The cooling system of claim 1, wherein the first wall comprises a carbon nanotube cloth.

14. The cooling system of claim 13, wherein the carbon nanotube cloth comprises having a surface to volume ration of 1350 m²/g.

15. The cooling system of claim 13, wherein the carbon nanotube cloth comprises nanotubes having a diameter in a range between 1 to 100 nm.

16. The cooling system of claim 13, wherein the carbon nanotube cloth comprises a size larger than the size of the interior surface of the first wall, and wherein a first portion of the carbon nanotube cloth facing the interior surface of the reactor is replaceable by rotating the carbon nanotube cloth such that a second-unexposed portion of the carbon nanotube cloth faces the interior of the reactor.

17. A cooling system of a reactor, the cooling system comprising:
a first wall comprising a low-Z material configured to absorb low energy photons; and
a second wall comprising a high-Z material;
wherein the first wall comprises a carbon nanotube cloth, wherein the carbon nanotube cloth is moveable such that a portion of the carbon nanotube cloth exposed to the interior of the reactor can be replaced with unexposed portion of the carbon nanotube cloth.

18. The cooling system of claim 17, wherein the reactor including a vacuum wall disposed beyond the first and second walls.

19. The cooling system of claim 17, further comprising a third wall configured to absorb neutron.

20. The cooling system of claim 17, wherein the first wall comprises carbon nanotubes bundles disposed within the first wall.

21. (canceled)
